(19) United States
(12) Patent Application Publication
(10) Pub. No.: US 2014/0091906 A1
(43) Pub. Date: Apr. 3, 2014

(54) VEHICLE REMOTE CONTROL SYSTEM AND METHOD

(71) Applicant: HYUNDAI MOTOR COMPANY, Seoul (KR)

(72) Inventor: Wan Lee, Wanju (KR)

(73) Assignee: Hyundai Motor Company, Seoul (KR)

(21) Appl. No.: 13/717,461

(22) Filed: Dec. 17, 2012

(30) Foreign Application Priority Data
Sep. 28, 2012 (KR) 10-2012-0109077

(51) Int. Cl. G05B 1/01

(52) U.S. Cl. CPC G05B 1/01
USPC 340/5.61; 340/5.72

(57) ABSTRACT

A vehicle remote control system and method are capable of remotely controlling opening and closing a door and/or a trunk of a vehicle. In particular, the method of remotely controlling a vehicle utilizes a remote control key including an operation button for remotely controlling a designated control target of the vehicle, and includes steps of: determining whether communication with the vehicle is possible; and notifying whether the communication with the vehicle is possible.

### CROSS-REFERENCE TO RELATED APPLICATION

This application claims priority to and the benefit of Korean Patent Application No. 10-2012-0109077 filed in the Korean Intellectual Property Office on Sep. 28, 2012, the entire contents of which are incorporated herein by reference.

### BACKGROUND

(a) Field of the Invention

The present invention relates to a vehicle remote control system and method capable of remotely controlling a control target of a vehicle, such as a door and/or a trunk of a vehicle.

(b) Description of the Related Art

According to the development of wireless communication technology, devices that utilize wireless communication have been variously developed and mounted to a vehicle. An example of a device related to wireless communication is a vehicle remote control system for remotely controlling a door, a trunk, and/or a starting motor of a vehicle through wireless communication.

A vehicle remote control system conventionally includes a remote control key possessed by a user (driver), and the remote control key is variously called a smart key, a FOB key, or a remote starting key. Accordingly, the remote control key for a vehicle can be referred to alternatively as a smart key, a FOB key, and a remote starting key and may incorporate wireless communication technology.

An example of a vehicle remote control key according to conventional technology is illustrated in FIG. 1.

Referring to FIG. 1, a driver possessing a vehicle remote control key 10 may lock a door of the vehicle by operating a door lock switch button 12 and unlock the door of the vehicle by operating an unlock switch button 14.

Further, the driver possessing the vehicle remote control key 10 may open a trunk by operating a trunk open switch button 16.

In addition, the driver possessing the vehicle remote control key 10 may identify a position of the vehicle by operating a vehicle position identification warning sound output switch button 18, which activates a horn of the vehicle, thereby alerting the driver as to the vehicle's position.

A display lamp 22 of the vehicle remote control key 10 is lit so as to display an operation state when the user operates a corresponding switch button.

The vehicle remote control key 10 may remotely control a control target (for example, the door and/or the trunk) installed at the vehicle through mutual wireless communication with a vehicle remote control module (not illustrated) installed at the vehicle. A combination of the vehicle remote control key and the vehicle remote control module is generally referred to as a vehicle remote control system.

The vehicle remote control key 10 illustrated in FIG. 1 may perform desired remote control only by operating a corresponding switch button. However, it is known to provide a vehicle remote control key such as a smart key or a FOB key that may automatically open/close the door through near field wireless communication between the vehicle and the vehicle remote control key without operating a switch button.

Further, it is illustrated in FIG. 1 that the vehicle remote control key 10 does not include a display window. However, the vehicle remote control key optionally may be provided with a display window to display a remote control state and/or other contents through a screen.

Since the vehicle remote control key is always in an operation standby state, the user may control the vehicle remote control key even in a case where the user is located beyond a wireless communicable distance (for example, 10 to 30 m) with the corresponding vehicle, thereby causing several problems.

That is, since the existing vehicle remote control key does not notify the user as to whether the vehicle remote control key is located within the wireless communicable distance with the corresponding vehicle, the user (driver) may unnecessarily consume power of a battery of the vehicle remote control key by operating the vehicle remote control key even at a distance from which wireless communication with the vehicle is impossible.

Further, since the user having the existing vehicle remote control key generally would not know the wireless communicable distance, the user may operate the vehicle remote control key even beyond the wireless communicable distance and in such a case, a desired operation is not performed, potentially causing the user to repeat the operation several times.

In addition, when the user repeats the operation of the vehicle remote control key more than a predetermined number of times (for example, a large number of times such as 256 times) beyond the wireless communicable distance, the vehicle remote control key autonomously enters an unserviceable state in order to prevent damage due to malfunction, so that the vehicle remote control key can be used only after being serviced by an authorized person, for example.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a vehicle remote control system and method which can reduce battery consumption of a remote control key and improve convenience of the vehicle remote control system by enabling a user (driver) to be notified that a distance between the vehicle remote control key and a control target vehicle is within a wireless communicable distance when the distance between the vehicle remote control key and the control target vehicle is actually within the wireless communicable distance, and switching a mode of the remote control key to a sleep mode when the distance between the vehicle remote control key and the control target vehicle is beyond the wireless communicable distance so that the remote control key is not operated even though the user attempts operation of the remote control key.

An exemplary embodiment of the present invention provides a method of remotely controlling a vehicle by using a remote control key including an operation button for remotely controlling a designated control target of the vehicle, the method including: determining, by a controller, whether communication with the vehicle is possible; and notifying, by the controller, whether the communication with the vehicle is possible.

The method may further include: detecting, by the controller, an operation of the operation button; and transmitting, by the controller, a signal corresponding to the operation of the operation button according to whether the communication with the vehicle is possible when the operation of the operation button is detected.

The transmitting of the signal corresponding to operation of the operation button according to whether the communication with the vehicle is possible may include transmitting a signal corresponding to the operation button to the vehicle when the communication with the vehicle is possible, and if communication is impossible, then transmitting no signal corresponding to the operation button to the vehicle.

Whether the communication with the vehicle is possible may be determined based on whether a radio signal including a unique identification code is received from the vehicle by the remote control key.

Another exemplary embodiment of the present invention provides a method of remotely controlling a vehicle by using a remote control key including an operation button for remotely controlling a designated control target of the vehicle, the method including: determining, by a controller, whether a radio signal transmitted from the vehicle transceiving the radio signal including a unique identification code is received; when it is determined that the radio signal is not received, maintaining a set sleep mode until the radio signal is received; and when it is determined that the radio signal is received, notifying, by the controller, a user of the reception of the radio signal and switching the sleep mode to an operation standby mode so as to transmit a corresponding control signal to the vehicle when an operation of the user is made.

When it is determined that the radio signal is received, reception of the radio signal may be notified via the remote control key at a predetermined time interval so that the user is notified as to reception of the radio signal.

When it is determined that the radio signal is received, a lamp of the remote control key may be lit for a predetermined time so that the user is notified as to reception of the radio signal.

When it is determined that the radio signal is received, a vibration body of the remote control key may be vibrated for a predetermined time so that the user is notified as to reception of the radio signal.

Yet another exemplary embodiment of the present invention provides a system for remotely controlling a vehicle, including: a remote control key including an operation button for remotely controlling a designated control target of the vehicle; a radio signal transceiver installed at the vehicle and configured to transceive a radio signal including a unique identification code; and a driving unit configured to control and operate the control target based on a signal of the radio signal transceiver of the vehicle, in which a microprocessor of the remote control key is configured to execute programming instructions including a series of commands for performing the method according to the exemplary embodiment of the present invention.

The remote control key may include: a radio signal receiver configured to receive the radio signal transmitted from the radio signal transceiver of the vehicle; a microprocessor configured to determine whether a radio signal transmitted from the radio signal transceiver of the vehicle is received in the radio signal receiver; and a radio signal transmitter configured to modulate a signal corresponding to an operation of a user to a radio signal including a unique identification code and transmit the modulated radio signal to the radio signal transceiver of the vehicle.

As described above, according to the exemplary embodiments of the present invention, when a distance between a vehicle remote controller (remote control key) and a control target vehicle is within a wireless communicable distance, a user (driver) is notified that the distance between the vehicle remote controller (remote control key) and the control target vehicle is within the wireless communicable distance, and when the distance between the vehicle remote controller (remote control key) and the control target vehicle is beyond a wireless communicable distance, the remote control key is not operated even though the user operates the remote control key, so that it is possible to reduce power consumption of a battery of the remote control key and improve convenience and merchantable quality of the vehicle remote control system.

### BRIEF DESCRIPTION OF THE DRAWINGS

FIG. 1 (PRIOR ART) is a schematic diagram of a remote control key according to an exemplary embodiment of conventional technology.

FIG. 2 is a schematic diagram of a remote control system according to an exemplary embodiment of the present invention.

FIG. 3 is a flowchart of a remote control method according to an exemplary embodiment of the present invention.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Additionally, it is understood that the below methods are executed by at least one controller. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, exemplary embodiments of the present invention will be described in detail with reference to the accompanying drawings.

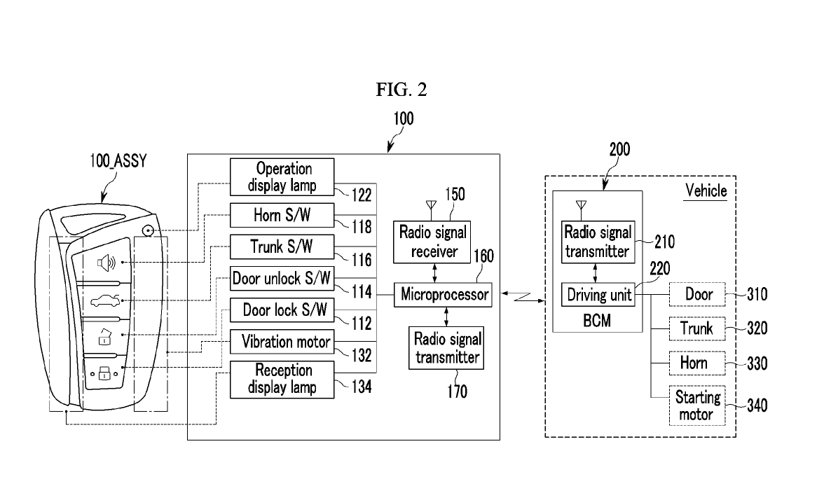

FIG. 2 is a schematic diagram illustrating a remote control system according to an exemplary embodiment of the present invention.

As illustrated in FIG. 2, the remote control system according to the exemplary embodiment of the present invention includes a remote controller 100 as a remote control key possessed by a driver or a user, and a vehicle control module 200 installed at a vehicle and including a radio signal transceiver (radio signal transmitter) 210 for transceiving a radio signal (for example, a high frequency radio signal (RF signal)) including a unique identification code.

It is apparent to a person of ordinary skill in the art that the remote controller 100 may be part of an assembly (e.g., a remote control key 100_ASSY as shown in FIG. 2) if the remote controller 100 is assembled with other related components, such as a case and a switch button, as illustrated in FIG. 2.

The vehicle control module 200 may include a driving unit 220 configure to control a door 310, a trunk 320, a horn 330, and a starting motor 340 based on a signal of the radio signal transceiver 210. The vehicle control module 200 may be a module equivalent to a body control module (BCM).

It has been mentioned that the control target of the vehicle control module 200 includes the door, the trunk, the horn, and the starting motor, but it should be understood that the scope of the present invention is not limited thereto. The present invention may be applied to any control target of the vehicle (for example, a lamp and/or a heating line) if the control target may be remotely controlled, and other control targets not mentioned herein are also encompassed by the present invention.

Accordingly, the vehicle control module may be configured to include a BCM and/or other control module, for example, an engine control unit (ECU) for controlling an operation of an engine, according to the remote control target.

As illustrated in FIG. 2, the remote controller 100 may include: a radio signal receiver 150 for receiving a radio signal transmitted from the radio signal transceiver 210 of the vehicle; a microprocessor 160 for determining whether the radio signal transmitted from the radio signal transceiver 210 of the vehicle is received in the radio signal receiver 150; and a radio signal transmitter 170 for modulating a signal corresponding to an operation of the remote control key 100_ASSY by the user to a radio signal (an RF signal that is a high frequency radio signal) including a unique identification code and transmitting the modulated radio signal to the radio signal transceiver 210 of the vehicle.

The radio signal receiver 150 and the radio signal transmitter 170 according to the exemplary embodiment of the present invention may employ a radio signal receiver and a radio signal transmitter implemented according to conventional technology, so that detailed descriptions thereof will be omitted.

The microprocessor 160 preferably is operated by a set program, and the set program includes a series of commands for performing a vehicle remote control method according to the exemplary embodiment of the present invention. The program including the series of commands (or programming instructions) is embodied in a non-transitory computer readable medium configured to be executed by the microprocessor 160.

The remote controller 100 according to the exemplary embodiment of the present invention may include one or more of a radio signal reception display lamp 134 and a vibration motor 132 for notifying or alerting the user as to reception of the radio signal when the radio signal transmitted from the radio signal transceiver 210 of the vehicle is received in the receiver 150 of the remote controller. When the reception of the radio signal transmitted from the radio signal transceiver 210 of the vehicle in the receiver 150 of the remote controller 100 is provided as a single notification, the user may not recognize the notification, so that the reception of the radio signal may be notified at a predetermined time interval (for example, an interval of ten minutes).

The reception display lamp 134 can provide a visual notification of the reception of the radio signal transmitted from the vehicle in the receiver 150. The reception display lamp 134 may be an LED or a lamp equivalent thereto. When the radio signal transmitted from the vehicle is received in the receiver 150, the microprocessor 160 provides a notification that the remote control key 100_ASSY is within an available distance (for example, 10 to 30 m) from the corresponding vehicle by lighting the reception display lamp 134 for a set time, for example, two seconds.

The vibration motor 132 can provide notification of the reception of the radio signal transmitted from the vehicle in the receiver 150 by using vibration. The vibration motor 132 may be a vibration motor widely used in a portable terminal, or a vibration motor equivalent thereto. When the radio signal transmitted from the vehicle is received in the receiver 150, the microprocessor 160 notifies the user that the remote control key 100_ASSY is within the available distance from the corresponding vehicle by vibrating the vibration motor 132 for a set time, for example, two seconds.

In the exemplary embodiment of the present invention, it is possible to selectively combine the reception display lamp 134 and the vibration motor 132, but it should be understood that the scope of the present invention is not limited thereto. For example, the present invention may be applied to a heating body capable of generating heat or a blower capable of making wind, other than the aforementioned components.

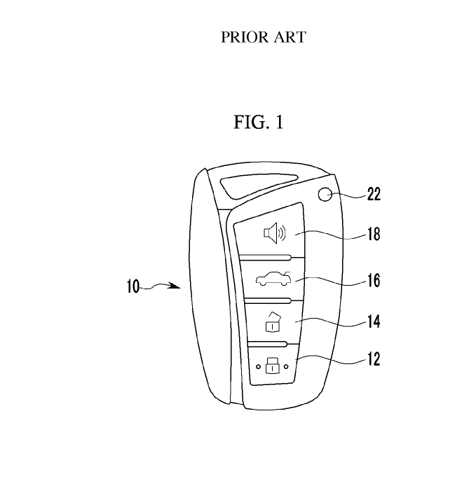

Further, the remote controller 100 according to the exemplary embodiment of the present invention includes the door lock remote control switch 112, the door unlock remote control switch 114, the trunk remote control switch 116, the horn remote control switch 118, and the operation display lamp 112, which correspond to the configuration of a conventional device (see FIG. 1).

Hereinafter, a vehicle remote control method according to an exemplary embodiment of the present invention will be described in detail with reference to the accompanying drawings.

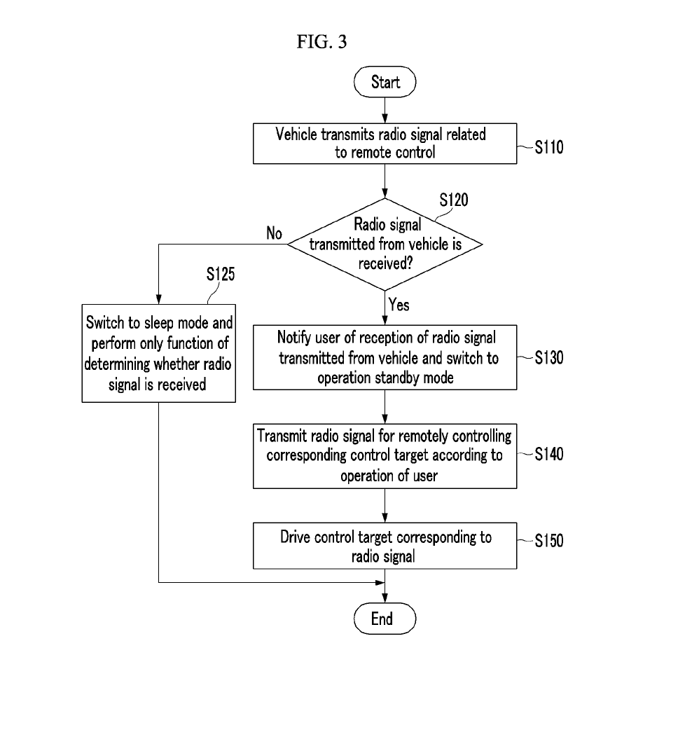

FIG. 3 is a flowchart illustrating a vehicle remote control method according to an exemplary embodiment of the present invention.

As illustrated in FIG. 3, the microprocessor 160 of the remote controller 100 identifies whether a radio signal (RF radio signal) transmitted from the radio signal transceiver 210 of the vehicle is received in the receiver 150 of the remote controller 100 (S110 and S120).

The transceiver 210 of the vehicle control module 200 regularly transmits the radio signal including a unique identification code identified only by the corresponding remote controller 100 by a set time interval, where such a radio signal incorporates known technology, so that a detailed description thereof will be omitted.

When the microprocessor 160 identifies that the radio signal transmitted from the vehicle is not received in the receiver 150 of the remote controller 100, the microprocessor 160 switches a mode of the remote controller 100 to a sleep mode (S 125).

The remote controller 100 performs only a function of determining whether the radio signal transmitted from the vehicle is received in the sleep mode, thereby preventing unnecessary power consumption of a battery (not illustrated) that serves as a driving power source of the remote controller 100. That is, the microprocessor 160 controls so that a corresponding operation attempted according to the user's operation is not performed even though the user presses buttons of the remote controller 100, thus maintaining the remote controller 100 in the sleep mode.

When a distance between the remote controller 100 and the corresponding vehicle is reduced sufficiently in the sleep mode state, that is, when a distance between the remote controller 100 and the radio signal transceiver 210 of the vehicle is a wireless communicable distance (for example, 10 to 30 m), the radio signal transmitted from the radio signal transceiver 210 of the vehicle is received in the receiver 150 of the remote controller 100. In this case, the microprocessor 160 identifies the reception of the radio signal transmitted from the radio signal transceiver 210 of the vehicle in the receiver 150 of the remote controller 100 and illuminates the reception display lamp 134 for a set time (for example, two seconds) according to a preset time interval (for example, ten minutes) and/or vibrates the vibration motor 132 by supplying power to the vibration motor 132 for a set time (for example, two seconds) so as to notify the user about the reception of the radio signal. When the user presses the button of the operation switch of the remote controller 100, the microprocessor 160 switches the sleep mode state to an operation standby mode so as to transmit a signal for remotely controlling a corresponding control target of the vehicle (S130).

When the user operates the button of the door unlock remote control switch 114 in order to open the corresponding control target (e.g., the door), so as to substantially unlock the door lock, in a state in which the sleep mode is switched to the operation standby mode, the microprocessor 160 senses the operation of the button of the door unlock remote control switch 114 and the radio signal transmitter 170 modulates a signal for unlocking the door lock into the radio signal to transmit the modulated radio signal to the vehicle (S 140).

When the signal for unlocking the door lock is modulated to the radio signal by the remote controller 100 and the modulated radio signal is received in the radio signal transceiver 210 of the vehicle, the driving unit 220 unlocks a door locking/unlocking motor (not illustrated) installed at the door 310 based on an output signal of the radio signal transceiver 210 of the vehicle, so as to open the door 310 (S 150).

Steps S140 and S150 describe a case in which the control target is the door 310, but it is apparent to a person of ordinary skill in the art that steps S140 and S150 will be similarly applied to the trunk 320, the horn 330, and the starting motor 340, and/or any other control target.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: Remote controller | 132: Vibration motor |
| 134: Reception display lamp | 150: Radio signal receiver |
| 160: Microprocessor | 170: Radio signal transmitter |
| 200: Vehicle control module | 210: Radio signal transmitter |
| 220: Driving unit | |

What is claimed is:

1. A method of remotely controlling a vehicle by using a remote control key including an operation button for remotely controlling a designated control target of the vehicle, the method comprising:
determining, by a controller, whether communication with the vehicle is possible; and
notifying, by the controller, whether the communication with the vehicle is possible.

2. The method of claim 1, further comprising:
detecting an operation of the operation button; and
transmitting a signal corresponding to the operation of the operation button according to whether the communication with the vehicle is possible when the operation of the operation button is detected.

3. The method of claim 2, wherein:
the step of transmitting the signal corresponding to the operation of the operation button according to whether the communication with the vehicle is possible further comprises:
transmitting the signal corresponding to the operation button to the vehicle when the communication with the vehicle is possible, and transmitting no signal corresponding to the operation button to the vehicle when the communication with the vehicle is impossible.

4. The method of claim 3, wherein:
the step of determining whether the communication with the vehicle is possible further comprises:
determining whether a radio signal including a unique identification code is received from the vehicle.

5. A method of remotely controlling a vehicle by using a remote control key including an operation button for remotely controlling a designated control target of the vehicle, the method comprising:
determining, by a control unit, whether a radio signal transmitted from the vehicle transceiving the radio signal including a unique identification code is received;
if it is determined that the radio signal is not received, maintaining a set sleep mode until the radio signal is received; and
if it is determined that the radio signal is received, notifying a user of reception of the radio signal and switching the sleep mode to an operation standby mode so as to transmit a corresponding control signal to the vehicle when an operation of the user is made.

6. The method of claim 5, wherein:
if it is determined that the radio signal is received, reception of the radio signal is notified by a predetermined time interval so that the user is notified as to reception of the radio signal.

7. The method of claim 6, wherein:
if it is determined that the radio signal is received, a lamp of the remote control key is lit for a predetermined time so that the user is notified as to reception of the radio signal.

8. The method of claim 6, wherein:
if it is determined that the radio signal is received, a vibration body of the remote control key is vibrated for a predetermined time so that the user is notified as to reception of the radio signal.

9. A system for remotely controlling a vehicle, comprising:
a remote control key including an operation button for remotely controlling a designated control target of the vehicle; and
a radio signal transceiver installed at the vehicle and configured to transceive a radio signal including a unique identification code; and
a driving unit configured to control and operate the control target based on a signal of the radio signal transceiver of the vehicle,
wherein the remote control key is configured to execute via a microprocessor program instructions comprising a series of commands for performing a method of remotely controlling a vehicle, the method comprising:
determining whether communication with the vehicle is possible;
notifying whether the communication with the vehicle is possible;
detecting an operation of the operation button; and
transmitting a signal corresponding to the operation of the operation button according to whether the communication with the vehicle is possible when the operation of the operation button is detected.

10. The system of claim 9, wherein:
the remote control key comprises:
a radio signal receiver configured to receive the radio signal transmitted from the radio signal transceiver of the vehicle;
the microprocessor configured to determine whether a radio signal transmitted from the radio signal transceiver of the vehicle is received in the radio signal receiver; and
a radio signal transmitter configured to modulate a signal corresponding to an operation of a user to a radio signal including a unique identification code and transmit the modulated radio signal to the radio signal transceiver of the vehicle.

11. The system of claim 9, wherein:
the remote control key comprises:
a lamp or a vibration body operated for a set time in order to notify as to reception of the radio signal when the radio signal transmitted from the radio signal transceiver of the vehicle is received in the radio signal receiver.

12. A non-transitory computer readable medium containing program instructions executed by a microprocessor within a remote control key, the computer readable medium comprising:
program instructions that determine whether communication with a vehicle is possible;
program instructions that notify whether the communication with the vehicle is possible;
program instructions that detect an operation of the operation button; and
program instructions that transmit a signal corresponding to the operation of the operation button according to whether the communication with the vehicle is possible when the operation of the operation button is detected.
